(19) United States
(12) Patent Application Publication
(10) Pub. No.: US 2009/0312061 A1
(43) Pub. Date: Dec. 17, 2009

(54) PORTABLE COMMUNICATION DEVICE HAVING A COMMON CORE MECHANICAL SUBASSEMBLY

(75) Inventor: Randolph C. Demuynck, Wake Forest, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/138,665

(22) Filed: Jun. 13, 2008

(51) Int. Cl. H04M 1/00

(52) U.S. Cl. 455/566; 455/575.4

(57) ABSTRACT

A portable communication device includes a common core base assembly including a metal frame. The common core base assembly is configured to couple to a plurality of different upper assemblies, thereby providing a portable communication device or family of portable communication devices having different form factors, while making use of a common core base assembly.

### TECHNICAL FIELD OF THE INVENTION

The present invention relates generally to portable communication devices, and more particularly, to a portable communication device and family of portable communication devices having a common core mechanical subassembly.

### DESCRIPTION OF RELATED ART

Portable communication devices, and in particular mobile telephones, are used for a wide variety of applications. For example, mobile phones are used not only for phone conversations and for sending/receiving messages, but also for browsing the internet, viewing multimedia content, such as movies or music, and for playing games, etc.

Mobile phones include a variety of different housings or form factors. For example, stick or block form factor mobile phones typically include a display and a keypad, e.g., a numeric keypad or a QWERTY keypad, with few, if any, moving parts or assemblies. In order to maximize the size of the display screen, some mobile devices are designed with a base and a display that is movable relative to the base. In these mobile phones, the keypad often is incorporated into the base and exposed only after opening/moving the display. Known mobile devices of this variety include clamshell devices, in which the display is connected to the base via a conventional rotational hinge, and slider devices, in which the display is slidable with respect to the base, for example, on a rail or a track.

### SUMMARY

To enhance functionality and versatility, as well as provide greater manufacturing flexibility and simplicity, a portable communication device includes a common core base assembly. The common core base assembly includes a metal frame at least partially covered by plastic depending upon the desired color and trim package. The common core base assembly is configured to support or otherwise house the device circuitry and to couple to a plurality of different upper assemblies corresponding to different form factors. The provision of a common core base assembly allows for a common element that houses most of the device components and is shared between varieties of form factors.

One aspect of the disclosed technology relates to a portable communication device that includes a common core base assembly having a metal frame and plastic formed at least partially over a portion of the metal frame, wherein the common core base assembly is configured to house portable communication device circuitry; an upper assembly coupled to the common core base assembly; and at least one end cap assembly coupled to the common core base assembly.

According to another aspect, the metal frame includes a top portion and a pair of side portions coupled to the top portion, wherein the top portion is configured to couple to the upper assembly.

According to another aspect, the common core base assembly defines a channel configured to receive a portion of the upper assembly.

According to another aspect, the common core base assembly is configured to couple to a variety of different upper assemblies having different form factors.

According to another aspect, the common core base assembly is configured to couple to a variety of different upper assemblies to define a stick form factor, a slider form factor or a clamshell form factor.

According to another aspect, the common core base assembly includes plastic insert molded at least partially over a portion of the metal frame.

According to another aspect, the metal frame is formed of extruded aluminum.

According to another aspect, the upper assembly comprises a slider assembly including a slider base coupled to the common core base assembly and a top portion slidingly engaging the slider base by a pair of rail assemblies.

According to another aspect, the slider assembly and common core base assembly cooperate to define a parting line on a top portion of the portable communication device.

According to another aspect, the slider assembly and the common core base assembly are coupled without defining a parting line on either side of the portable communication device.

According to another aspect, the upper assembly comprises a flip assembly coupled to the common core base assembly, wherein the flip assembly includes a support portion coupled to a top portion of the metal frame and a top portion hingedly coupled to the support portion such that the top portion is configured to rotate relative to the common core base assembly, wherein the flip assembly and the common core base assembly define a clamshell form factor.

According to another aspect, the upper assembly comprises a display and a keypad, wherein the upper assembly and the common core base assembly define a stick form factor.

According to another aspect, the end cap comprises a variable-length end cap.

According to another aspect, the length of the end cap is modified according an antenna volume or geometry required by an antenna housed within the common core base assembly.

According to another aspect, the portable communication device is a mobile telephone.

Another aspect of the disclosed technology relates to a method of fabricating a family of mobile phones having different form factors. The method includes forming a common core base assembly that includes a metal frame and plastic formed at least partially over a portion of the metal frame; and coupling the common core base assembly to a plurality of different upper assemblies having different form factors, thereby providing a plurality of mobile phones having a stick form factor, a clamshell form factor, and a slider form factor.

According to another aspect, coupling includes securing each upper assembly to an upper portion of the metal frame via at least one fastener.

According to another aspect, the method further includes providing mobile phone circuitry within a cavity defined by the common core base assembly; and providing an end cap over at least one end of the common core base assembly.

Another aspect of the disclosed technology relates to a common core base assembly for use in connection with a plurality a mobile phones having different form factors. The common core base assembly includes a metal frame having a top portion and a pair of side portions, and a plastic body portion formed at least partially over the metal frame, wherein the common core base assembly is configured to house mobile phone circuitry, and wherein the common core base assembly is configured to couple to a plurality of different upper assemblies having different form factors.

According to another aspect, the common core base assembly is configured to couple a variety of different upper assemblies to define a stick form factor, a slider form factor or a clamshell form factor.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a perspective view of a frame portion of a common core base assembly in accordance with one aspect of the disclosed technology;

FIG. 2 is a perspective view of a common core base assembly in accordance with one aspect of the disclosed technology;

FIG. 3 is a sectional view of an exemplary stick mobile phone including a common core base assembly;

FIG. 4 is a sectional view of an exemplary slider mobile phone including a common core base assembly;

FIG. 5 is a sectional view of an exemplary clamshell mobile phone including a common core base assembly;

FIG. 6 is a side view of an exemplary end cap for use in connection with the common core base assembly;

FIG. 7 is a side view of a flip upper assembly configured to couple to the common core base assembly;

FIG. 8 is a top view of an exemplary slider mobile phone in a closed configuration;

FIG. 9 is a top view of the slider mobile phone of FIG. 8 is an open configuration;

FIG. 10 is a sectional view of the slider mobile phone of FIG. 8; and

FIG. 11 is a diagrammatic illustration of exemplary mobile phone circuitry housed within the common core base assembly.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As referred to herein, the term “portable communication device” includes portable radio communication equipment. The term “portable radio communication equipment”, which herein after is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like.

In the context of the illustrated embodiments, the portable communication device is primarily referred to as a mobile telephone or a mobile phone. The description and illustrations of the mobile telephone, however, are intended to serve as a non-limiting exemplary environment for the inventive concepts described herein, and it will be appreciated that the invention is not intended to be limited to a mobile telephone, but rather can be any type of electronic equipment.

Mobile phone designs are constantly evolving as designers struggle with phone size over function, performance, e.g., radio frequency (RF) performance, Bluetooth performance and Advanced Global Positioning System (AGPS) performance, and convenience. In one respect, mobile phones having smaller footprints are desirable for their portability. Examples of such phones include phones having a clamshell form factor in which a top portion of the phone rotates between open and closed positions relative to the base, which typically includes a keypad. Another example of a phone having a smaller form factor is a “slider phone.” Mobile phones with slider hinges typically include a keypad on the base that is exposed by sliding the display vertically and/or horizontally relatively to the base.

There is pressure on research and development efficiency to provide quickly mobile phones with aesthetically pleasing designs and improved function and performance. Due to the differences in overall form factor between stick phones, slider phones and clamshell phones, development cycles for new mobile phones often are longer than manufacturers would like.

The present disclosure recognizes challenges with conventional mobile phone design processes and manufacturing for a variety of mobile phone configurations, such as stick phones, slider phones and clamshell phones, and provides a mobile phone and method of manufacturing a family of mobile phones including a common core base assembly. The common core base assembly includes a metal frame over which various plastic configurations may be molded, e.g., insert molded. The common core base assembly is configured to be mounted to a variety of upper assemblies depending upon the desired type of housing. For example, the common core base assembly may be mounted to a simple display top assembly to form a stick mobile phone, to a flip top assembly to form a clamshell mobile phone, or to a slider top assembly to form a slider mobile phone.

The provision of a mobile phone and method of manufacturing that includes a common core base assembly allows for a more streamlined development cycle and greater versatility in that the common core base assembly may be easily employed with stick, slider and clamshell form factors. Further, the common core base assembly provides other aesthetic and design benefits described more fully below.

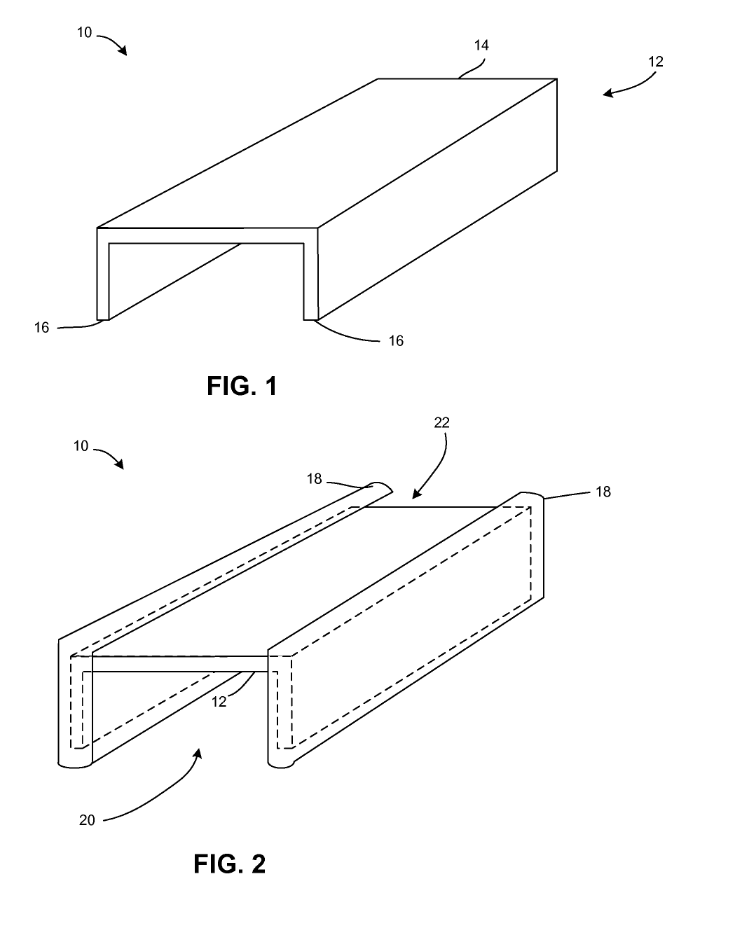

Referring initially to FIG. 1 and FIG. 2, an exemplary embodiment of a common core base assembly 10 is provided. As is described more fully below, the common core base assembly is configured to house mobile phone circuitry, e.g., processors, receivers, antennae, a battery, a camera module and the like, as well as to couple to several different upper assemblies, thereby providing mobile phones having different form factors.

In a preferred embodiment, the common core base assembly 10 includes a metal frame, e.g., an aluminum frame such as a frame made of extruded aluminum. Of course, the frame may be made of other metals or non-metal materials without departing from the scope of the present invention. The frame 12 includes a top portion 14 and a pair of side portions 16.

As shown in FIG. 2, the common core base assembly includes plastic body portions (designated generally by numeral 18) disposed at least partially over a portion of the metal frame, e.g., by insert molding or by another suitable molding process. It will be appreciated that the frame may be made of another metal or another rigid lightweight material onto which plastic is molded or otherwise disposed. Further, it will be appreciated that the frame may be covered or shot with plastic to the desired size, color and trim package for the particular mobile phone being manufactured.

As shown in FIG. 2, the common core base assembly includes a top portion and a pair of side portions. Further, the common core base assembly defines a channel 20 for supporting or otherwise housing the device circuitry. In addition, the frame and the molded plastic portions cooperate to define a channel or other area (designated by numeral 22) configured to receive an upper assembly, where the upper assembly may be comprised of components to define one of a number of different form factors, e.g., a stick form factor, a slider form factor, or a clamshell form factor.

In one embodiment, the common core base assembly 10 may be configured to have dimensions that allow for a relatively small and convenient form factor, while still being large enough to house a printed circuit board assembly (PCBA), a Bluetooth antenna, an Advanced Global Positioning System (AGPS) antenna, a main antenna, a battery, a camera with associated flash electronics and the like. In one embodiment, the common core base assembly has a width of about forty-eight millimeters (48 mm), a length of about ninety-five millimeters (95 mm), and a height of about eight millimeters (8 mm). Of course, it will be appreciated that the common core base assembly 10 may have other dimensions (larger or smaller) without departing from the scope of the present invention. As will be understood from the following discussion, because the common core base assembly is configured to house or otherwise support virtually all of the mobile phone electronics, it facilitates easy manufacture in high volume due to the fact that virtually all of the flexes and connections are disposed within the common core base assembly below the top portion of the frame.

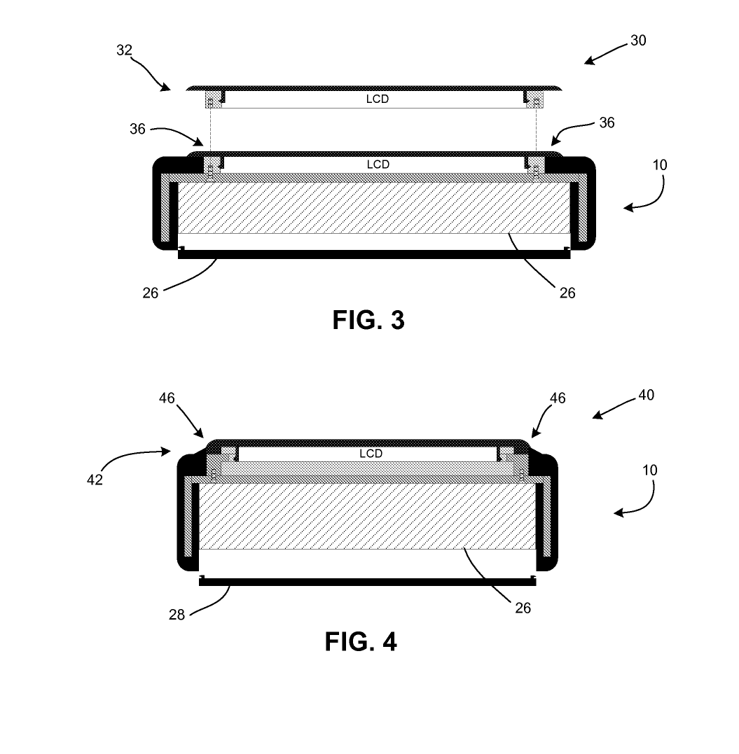

Turning now to FIGS. 3-5, it can be seen that the common core base assembly 10 is configured to couple to a variety of upper assemblies, thereby providing a family of mobile phones having different form factors, yet having the same common core base assembly 10, including common circuitry, antennae and the like. For purposes of illustration and explanation, a battery 26 is shown disposed within the common core base assembly 10 and a bottom cover 28 is shown partially removed in each of the sectional view of FIGS. 3-5.

For example, FIG. 3 shows an exemplary stick mobile phone 30 in which the upper assembly 32 is made up of a display 34, a receiver and keypad subassembly that may be simply screwed or otherwise fastened onto the common core base assembly unit via appropriate fasteners 36 such as screws or the like.

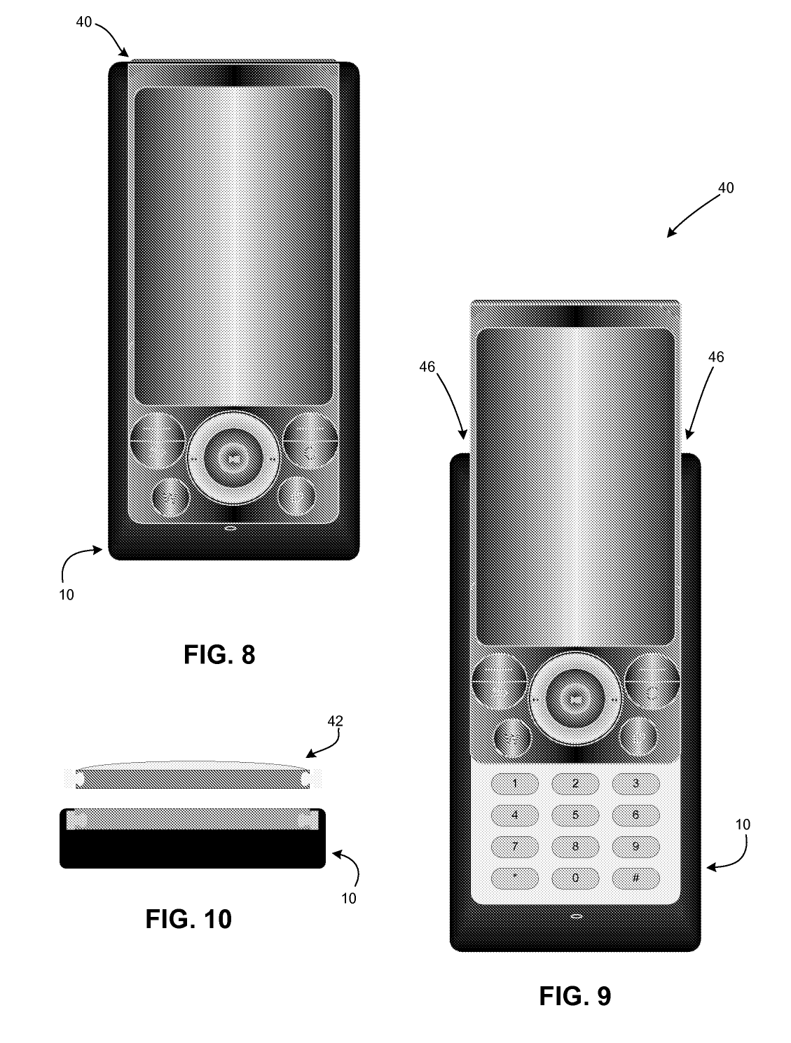

FIG. 4 shows an exemplary slider form factor mobile phone 40 in which the upper assembly 42 is comprised of a slider assembly. As can be seen from FIG. 4, the slider assembly rests substantially entirely within the channel or area defined by the top of the common core base assembly. This serves to provide a slider form factor in which there are no parting lines on the sides of the mobile phone. Stated differently, the upper slider assembly 42 and the common core base assembly 10 cooperate to provide a slider form factor in which parting lines are only seen on the top of the phone where the upper assembly meets the common core base assembly (indicated generally by arrows 46). FIGS. 8 and 9 show an exemplary slider in closed and open positions, respectively. Again, the common core base assembly and the slider upper assembly cooperate provide parting lines 46 on the top of the phone, but not on the sides of the phone.

The slider upper assembly 42 may be fastened to the common core base assembly 10 using any suitable fastener, for example, simply screwing the slider upper assembly into the common core base assembly from the underside of the common core base assembly. In one exemplary embodiment, the slider assembly includes a slider frame that is an entire subassembly including guide rails (see, for example, FIG. 10), external navigation, LCD, protective/cosmetic window and a receiver unit. In this embodiment, the slider mechanism may simply be a channel system with the above-mentioned components used to assemble it. It also may be made of aluminum, therefore providing substantial strength and linearity without excessive weight. It will be appreciated that the slider upper assembly may be produced and tested separately and in multiple color and trim options thereby providing greater manufacturing simplicity. It also will be appreciated that the slider form factor and stick form factor may include plastic end caps 48 that snap into the base when in the slider form factor (see, for example, FIG. 6).

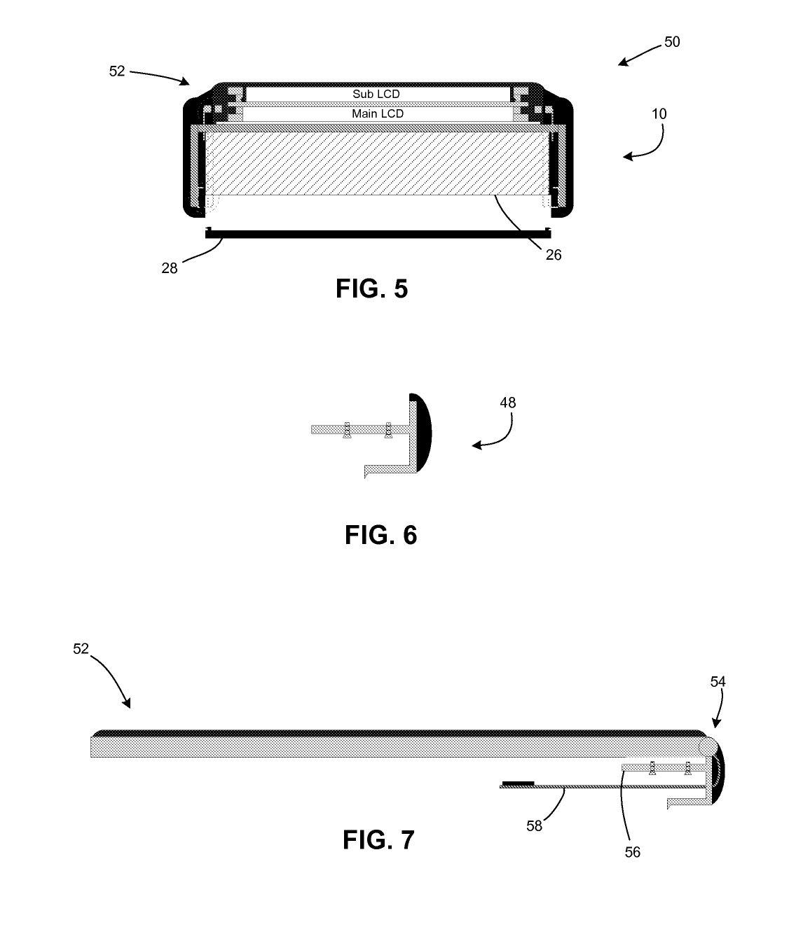

Turning now to FIG. 5, another exemplary embodiment is shown in which the common core base assembly 10 is coupled with a flip upper assembly 52, thereby providing a mobile phone having a clamshell form factor. It will be appreciated that the common core base assembly 10 includes the same structure as is employed in connection with the above-described stick mobile phone 30 embodiment and slider mobile phone 40 embodiment. In the clamshell embodiment, a clamshell hinge assembly 54 may snap into place where one of the plastic end caps was disposed on the slider form factor. FIG. 7 shows an exemplary flip upper assembly 52. In one embodiment, the flip upper assembly 52 may include a support member 56 configured to engage the upper portion of the common core base assembly frame, for example, being held to the upper portion of the frame by suitable fasteners such as screws. Similar to the slider upper assembly, the combined hinge/mechanism may be manufactured as an entire subassembly that can be mass produced and tested in multiple color and trim options. It will be appreciated that the strength of the flip upper assembly 52 is at least partially achieved by an aluminum channel that supports the main LCD and sub LCDs. The flex assembly 58 may be routed through the hinge and into the base in a simple fashion mainly because there are only a few electrical components in the flip upper assembly 52.

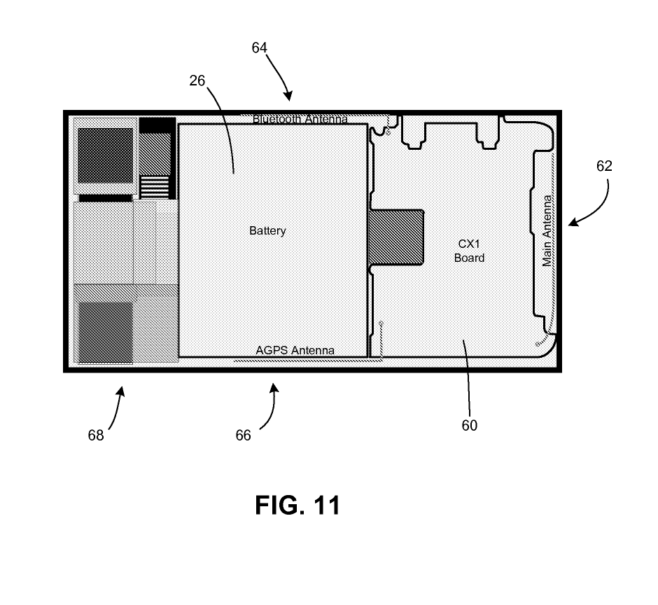

FIG. 11 shows an exemplary bottom view of circuitry supported or otherwise housed within the common core base assembly. It will be appreciated that virtually all of the components and electrical connections associated with the mobile phone may be made and housed within the common core base assembly. For example, the common core base assembly is configured and sized to house the battery 26, a printed circuit board assembly 60, a main antenna 62, a Bluetooth antenna 64, an AGPS antenna 66 and associated circuitry, a camera and flash unit 68 and the like.

Further, the common core base assembly is configured to provide improved radio frequency (RF) performance, which is often determined by the antenna volume, e.g., volume or geometry of the main antenna 62. In this design, metallic components are kept away from the antenna assembly 62 while the printed circuit board assembly is kept in relatively close proximity, for example, so a long coaxial cable is not needed to connect the printed circuit board assembly to the antenna, etc. One added benefit of this configuration is that there is very little at this end of the phone other than the substantially plastic end cap 46. So, for example, if it is determined that the antenna volume provided by a common core base assembly of a given volume is not sufficient, extending the length of the phone, for example, by a millimeter at a time, to better the antenna performance may be as simple as just extending the plastic base and the end cap. For example, if it is determined that an additional millimeter of space is required to provide preferred antenna performance, the end cap 46 may be made one millimeter deeper to accommodate the extra millimeter of space required to increase the antenna volume. It will be appreciated that other simple design modifications may be employed without requiring a complete redesign of the phone. Further, as shown in FIG. 11, the Bluetooth antenna 64 and the AGPS antenna 66 locations in this design also are optimized. In the illustrated exemplary embodiment, the antennas are positioned in a channel along side the battery. In this configuration, each antenna is isolated from the battery by a plastic battery compartment wall and this channel may be configured to go from the top of the phone to the bottom of the phone.

The provision of a mobile phone or a mobile phone family having a common core base assembly provides a number of design, development and manufacturing benefits. For example, the same common core base assembly may be used with a number of upper assemblies, thereby providing a number of form factors that include the same common core base assembly. As such, the same hardware components can be used for each form factor or variant, for example, the same printed circuit board assembly, camera and battery may be used in a slider form factor, a stick form factor and a clamshell form factor. Sharing of core parts across multiple form factors provides a number of design and cost benefits, such as ease of managing inventory and end of life considerations. Further, the simplistic design may reduce lifetime return rate and provide customer service with fewer unique parts to warehouse. In addition, the provision of a family of mobile phone assemblies provides an easier way to market a product line to multiple customers who may enjoy different form factors.

Further, other marketing possibilities exist, such as offering customers the ability to alter the form factor of their phone within a predetermined time after purchase. Because of the ease of assembling the upper assembly to the common core base assembly, this may be achieved without jeopardizing data that may already be stored in a phone's memory. Further, the provision of a common core base assembly having a metal frame and inserted molded plastic over a portion of the metal frame provides advantages such as overall strength and stability. As is discussed above, in the slider form factor embodiment, very clean surfaces and nearly nonexistent parting lines can be achieved on the device.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a common core base assembly that includes a metal frame and plastic formed at least partially over a portion of the metal frame, wherein the common core base assembly is configured to house portable communication device circuitry;
an upper assembly coupled to the common core base assembly; and
at least one end cap assembly coupled to the common core base assembly.

2. The portable communication device of claim 1, wherein the metal frame includes a top portion and a pair of side portions coupled to the top portion, wherein the top portion is configured to couple to the upper assembly.

3. The portable communication device of claim 1, wherein the common core base assembly defines a channel configured to receive a portion of the upper assembly.

4. The portable communication device of claim 1, wherein the common core base assembly is configured to couple to a variety of different upper assemblies having different form factors.

5. The portable communication device of claim 1, wherein the common core base assembly is configured to couple to a variety of different upper assemblies to define a stick form factor, a slider form factor or a clamshell form factor.

6. The portable communication device of claim 1, wherein the common core base assembly includes plastic insert molded at least partially over a portion of the metal frame.

7. The portable communication device of claim 1, wherein the metal frame is formed of extruded aluminum.

8. The portable communication device of claim 1, wherein the upper assembly comprises a slider assembly including a slider base coupled to the common core base assembly and a top portion slidingly engaging the slider base by a pair of rail assemblies.

9. The portable communication device of claim 8, wherein the slider assembly and common core base assembly cooperate to define a parting line on a top portion of the portable communication device.

10. The portable communication device of claim 8, wherein the slider assembly and the common core base assembly are coupled without defining a parting line on either side of the portable communication device.

11. The portable communication device of claim 1, wherein the upper assembly comprises a flip assembly coupled to the common core base assembly, wherein the flip assembly includes a support portion coupled to a top portion of the metal frame and a top portion hingedly coupled to the support portion such that the top portion is configured to rotate relative to the common core base assembly, wherein the flip assembly and the common core base assembly define a clamshell form factor.

12. The portable communication device of claim 1, wherein the upper assembly comprises a display and a keypad, wherein the upper assembly and the common core base assembly define a stick form factor.

13. The portable communication device of claim 1, wherein the end cap comprises a variable-length end cap.

14. The portable communication device of claim 1, wherein the length of the end cap is modified according an antenna volume or geometry required by an antenna housed within the common core base assembly.

15. The portable communication device of claim 1, wherein the portable communication device is a mobile telephone

16. A method of fabricating a family of mobile phones having different form factors, the method comprising:
forming a common core base assembly that includes a metal frame and plastic formed at least partially over a portion of the metal frame; and
coupling the common core base assembly to a plurality of different upper assemblies having different form factors, thereby providing a plurality of mobile phones having a stick form factor, a clamshell form factor, and a slider form factor.

17. The method of claim 16, wherein coupling includes securing each upper assembly to an upper portion of the metal frame via at least one fastener.

18. The method of claim 17, further comprising:
providing mobile phone circuitry within a cavity defined by the common core base assembly; and
providing an end cap over at least one end of the common core base assembly.

19. A common core base assembly for use in connection with a plurality a mobile phones having different form factors, the common core base assembly comprising:
a metal frame having a top portion and a pair of side portions, and a plastic body portion formed at least partially over the metal frame, wherein the common core base assembly is configured to house mobile phone circuitry, and wherein the common core base assembly is configured to couple to a plurality of different upper assemblies having different form factors.

20. The common core base assembly of claim 19, wherein the common core base assembly is configured to couple a variety of different upper assemblies to define a stick form factor, a slider form factor or a clamshell form factor.
